(19) United States
(12) Patent Application Publication
(10) Pub. No.: US 2016/0108653 A1
(43) Pub. Date: Apr. 21, 2016

(54) DETENT MECHANISM FOR A MOTOR VEHICLE COMPONENT

(71) Applicant: Brose Schliesssysteme GmbH & Co. KG, Wuppertal (DE)

(72) Inventors: Serkan Guelkan, Hattingen (DE); Karsten Barth, Hattingen (DE); Petr Vidomus Holub, Pribor (CZ); Petr Hranicky, Frydek Mistek (CZ)

(21) Appl. No.: 14/918,235

(22) Filed: Oct. 20, 2015

(30) Foreign Application Priority Data
Oct. 20, 2014 (DE) 20 2014 105 005.1

(51) Int. Cl. E05C 19/02

(52) U.S. Cl. CPC E05C 19/02

(57) ABSTRACT

A detent mechanism for a motor vehicle component has a pivotable holding part and a pivotable blocking part. The holding part is pivotable into a closing position and an open position about a holding part axis. A blocking state is produced by the blocking part being pivotable into a blocking position in which a blocking surface of the blocking part and a blocking surface of the holding part are in blocking engagement with each other and block a pivoting movement of the holding part out of the closing position in the direction of the open position. The blocking part is pivotable into a release position in which the blocking surfaces are disengaged from each other and release the holding part. In some cases, in the blocking state, a supporting surface of the blocking part and a supporting surface of the holding part are in axially supporting engagement with each other.

### CLAIM OF PRIORITY

This application claims the benefit of German Patent Application No. DE 20 2014 105 005.1, filed Oct. 20, 2014, the disclosure of which is incorporated by reference herein in its entirety.

### FIELD OF THE TECHNOLOGY

The application relates to a detent mechanism for a motor vehicle component and to a motor vehicle component with such a detent mechanism.

### BACKGROUND

The detent mechanism under discussion is used in a motor vehicle wherever high holding forces have to be absorbed in the blocking state. In the foreground here is the use of the detent mechanism in a motor vehicle lock which, in turn, can be used in all types of closure elements of a motor vehicle. These include, for example, side doors, in particular sliding doors, tailgates, rear lids, engine hoods, loading compartment floors or the like of a motor vehicle.

The detent mechanism under discussion can also be used for other motor vehicle components, for example seatbelt systems, seat adjustors, steering wheel locks or the like.

The known detent mechanism (DE 20 2013 004 589 U1), on which the invention is based, is assigned to a motor vehicle lock. It has a holding part which is designed as a lock latch and to which a blocking part designed as a pawl is assigned. In a blocking state, the lock latch is blocked in the pre-closing position thereof or in the main closing position thereof such that the lock latch cannot pivot into the open position thereof. In the closing positions, the lock latch is in holding engagement with a striker, and therefore the associated closure element is held in the respective closed position thereof. The release of the lock latch by the pawl leads to the lock latch being adjustable into the open position thereof in which the lock latch releases the striker and therefore the closure element.

In the known detent mechanism, the blocking part and the holding part each have a blocking surface, which blocking surfaces, in the blocking state, are in blocking engagement with each other and block a corresponding pivoting movement of the holding part in the direction of the open position. The blocking surface of the lock latch is arranged on the outer circumference of the lock latch and is designed running substantially along the holding part axis.

A challenge in the case of the known detent mechanism is the ensuring of a high degree of crash safety. In certain crash situations, high holding forces act on the striker, which may lead to deformation of structural parts of the motor vehicle lock. Such a deformation is often associated with an axial offset with respect to the holding part axis between the blocking surfaces. In the extreme case, the necessary overlap, which is required for the blocking engagement, between the blocking surfaces is no longer provided, and therefore the pawl slips off the lock latch. In order to avoid such slipping, the known motor vehicle lock has to be designed in a particularly robust construction. This is associated with the use of relatively costly materials and the likewise costly realization of high wall thicknesses of the structural parts involved.

### SUMMARY

This disclosure is directed to, among other things, the problem of designing and developing the known detent mechanism in such a manner that a high degree of crash safety can be provided at low costs. Embodiments of a detent mechanism directed to the foregoing are described herein.

The basic consideration is essentially that the primary factor for ensuring the blocking engagement is to limit the axial offset with respect to the holding part axis between the blocking surfaces. It can basically be accepted here that the two blocking surfaces which are in engagement with each other undergo an axial movement in the event of a crash. Against this background, it is proposed that in the blocking state, in order to limit an axial offset, with respect to the holding part axis, between the blocking surfaces, a supporting surface of the blocking part and a supporting surface of the holding part are in axially supporting engagement with each other or can be brought into axially supporting engagement with each other.

With the proposed solution, a cost-effective configuration of the components of the detent mechanism is possible since the functionally necessary relative positioning of the blocking surfaces with respect to each other is ensured even if the blocking surfaces are in each case displaced axially. Such an axial displacement may occur, as discussed above, because of the holding forces occurring in the event of a crash.

According to one aspect of embodiments of the invention, in normal operation, the supporting surface of the holding part and the supporting surface of the blocking part are disengaged from each other. It can therefore be ensured that the supporting surfaces do not obstruct the function of the detent mechanism during normal operation.

In some cases, the supporting engagement takes place wherever said engagement is primarily necessary. Accordingly, provision is made here for the supporting engagement to take place in the vicinity of the blocking engagement.

Optionally, the supporting surfaces, on the one hand, and the blocking surfaces, on the other hand, are arranged with respect to one another in a manner offset axially with respect to the holding part axis. This means that the supporting surfaces, on the one hand, and the blocking surfaces, on the other hand, can be designed independently of one another, which permits structurally simple solutions.

Some implementations of the invention relate to the design of the motor vehicle component as a motor vehicle lock comprising lock latch and pawl. The use of the proposed detent mechanism in a motor vehicle lock is appropriate in so far as, as discussed above, particularly high holding forces may act on the striker in the event of a crash, which may lead to deformation of the involved structural components of the motor vehicle lock.

In at least one case, a dual use of the supporting portion of the pawl that provides the supporting surface consists in that the supporting portion additionally provides an engagement depth limit for the pawl. Said dual use leads to a structurally simply and in particular compact construction.

According to a further teaching, a motor vehicle component is equipped with a proposed detent mechanism as described herein. Reference may be made to all of the statements regarding the proposed detent mechanism.

In some implementations, the motor vehicle component is an above-discussed motor vehicle lock comprising lock latch and pawl. In the blocking state, the lock latch may be enclosed between the supporting surface of the pawl and the striking plate. As a result, a particularly high degree of crash reliability in the above sense can be realized with simple structural measures.

In an embodiment, provided is a detent mechanism for a motor vehicle component, such as a motor vehicle lock, comprising a pivotable holding part and a pivotable blocking part, the holding part being pivotable into a closing position, such as a pre-closing position and a main closing position, and into an open position about a holding part axis, a blocking state being produced by the blocking part being pivotable into a blocking position in which a blocking surface of the blocking part and a blocking surface of the holding part are in blocking engagement with each other and block a pivoting movement of the holding part out of the closing position in the direction of the open position, the blocking part being pivotable into a release position in which the blocking surfaces are disengaged from each other and release the holding part, wherein, in the blocking state, in order to limit an axial offset, with respect to the holding part axis, between the blocking surfaces, a supporting surface of the blocking part and a supporting surface of the holding part are in axially supporting engagement with each other or can be brought into axially supporting engagement with each other.

In an embodiment, during normal operation, the supporting surface of the holding part and the supporting surface of the blocking part form a gap.

In an embodiment, in the blocking state, the supporting engagement is provided in the vicinity of the blocking engagement.

In an embodiment, the supporting surface of the blocking part is an integral component of the blocking part, and/or in that the supporting surface of the holding part is an integral component of the holding part.

In an embodiment, the supporting surface of the blocking part and/or the supporting surface of the holding part run or runs substantially perpendicularly to the holding part axis.

In an embodiment, the blocking surface of the blocking part and/or the blocking surface of the holding part substantially run or runs along the holding part axis.

In an embodiment, the supporting surface of the blocking part and the supporting surface of the holding part are arranged with respect to the blocking surface of the blocking part and/or the blocking surface of the holding part in a manner offset axially with respect to the holding part axis.

In an embodiment, the holding part is a lock latch of a motor vehicle lock, which lock latch, when a fitted motor vehicle lock is in the closing position, is in holding engagement with a striker or the like, and the blocking part is a pawl of the motor vehicle lock.

In an embodiment, the lock latch is of substantially disk-shaped design, wherein the blocking surface of the lock latch is arranged on the outer circumference of the lock latch, and wherein the supporting surface of the lock latch is arranged on a flat side of the lock latch.

In an embodiment, both the supporting engagement and the blocking engagement are provided in the region of the outer circumference of the lock latch.

In an embodiment, the supporting surface of the pawl is a component of a supporting tab which furthermore protrudes from the pawl. In an embodiment, the pawl is designed as a punched and bent part, and wherein the supporting tab is furthermore bent away from the pawl.

In an embodiment, that supporting portion of the pawl which provides the supporting surface, such as the supporting tab, provides an engagement depth limit, such as the supporting portion comes into engagement with a limit contour at a predetermined engagement depth of the pawl, and furthermore wherein the limit contour is arranged on the lock latch.

In an embodiment, a motor vehicle component, such as motor vehicle lock, comprises a detent mechanism as described herein.

In an embodiment, the holding part is a lock latch of a motor vehicle lock, which lock latch, when a fitted motor vehicle lock is in the closing position, is in holding engagement with a striker or the like, and the blocking part is a pawl of a motor vehicle lock, such as wherein a striking plate, in particular, is provided for receiving bearing pins for the lock latch and the pawl, and wherein, in the blocking state, the lock latch is enclosed between the supporting surface of the pawl and the striking plate.

In an embodiment, in the fitted state, a high, in particular crash-induced, holding force acting on the striker or the like leads to deformation of the motor vehicle lock, the deformation being substantially associated with an axial shifting of the blocking surface of the lock latch, and wherein the blocking surface of the pawl substantially follows said axial shifting by means of the supporting engagement between the supporting surfaces.

### BRIEF DESCRIPTION OF THE DRAWINGS

The invention is explained in more detail below with reference to a drawing depicting just one exemplary embodiment. In the drawing

FIG. 1 shows an entirely schematic top view of a proposed motor vehicle lock with a proposed detent mechanism with the components essential for explaining the invention in the case of a lock latch in the open position,

FIG. 2 shows the motor vehicle lock according to FIG. 1 a) with the lock latch in the pre-closing position and b) with the lock latch in the main closing position, and

FIG. 3 shows a perspective, partially sectioned view of the motor vehicle lock according to FIG. 1 in the completely fitted state.

### DETAILED DESCRIPTION

Referring to the figures, it should be pointed out in advance that the drawings only illustrates those components of the proposed detent mechanism 1 and of the proposed motor vehicle lock 2 that are necessary for explaining the teaching For example, an optionally provided lock mechanism of the motor vehicle lock 2 in order to realize functional states, such as “locked”, “unlocked”, “theft-protected” or the like is not illustrated.

The detent mechanism 1 illustrated can be used in various motor vehicle components of a motor vehicle. In the exemplary embodiment which is illustrated, the detent mechanism 1 is assigned to a motor vehicle component designed as a motor vehicle lock 2. In a corresponding manner, a pivotable holding part 4 designed as a lock latch 3 and a pivotable blocking part 6 designed as a pawl 5 are provided here. All of the statements regarding a holding part 4 apply correspondingly to a lock latch 3 (and vice versa). All of the statements regarding a blocking part 6 likewise correspondingly apply to a pawl 5 (and vice versa).

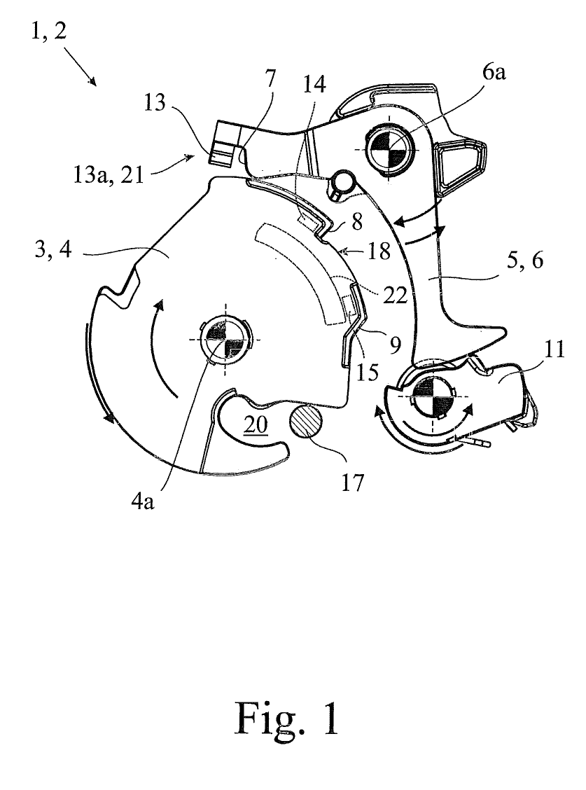

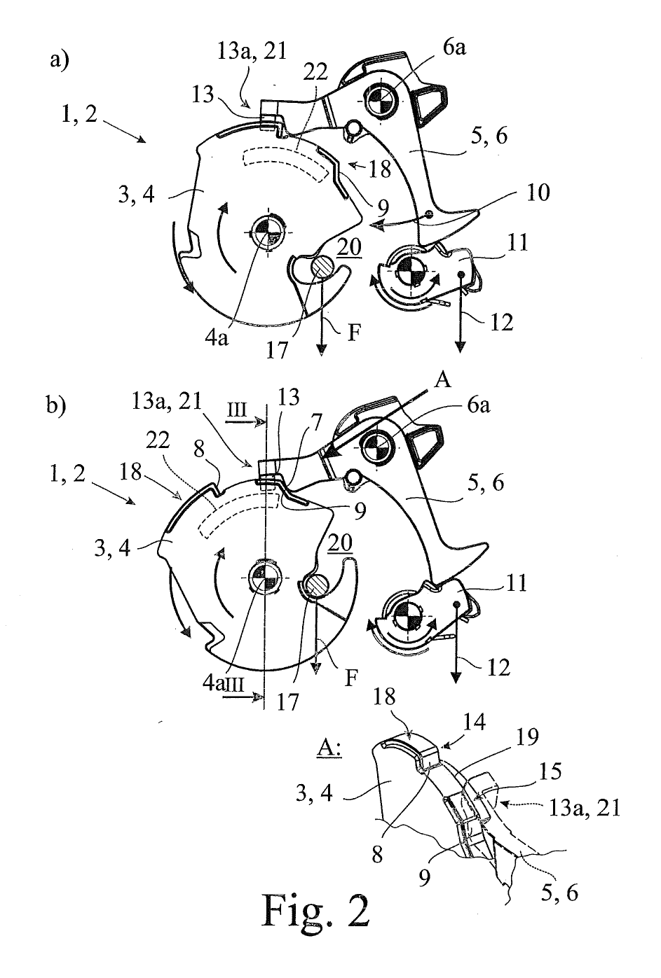

The holding part 4 is pivotable about a holding part axis 4a into at least one closing position, here into the pre-closing position (FIG. 2a) and into the main closing position (FIG. 2b). Furthermore, the holding part 4 is pivotable into an open position (FIG. 1). The blocking part 6 is pivotable about a blocking part axis 6a. The holding part axis 4a and the blocking part axis 6a can be arranged spaced apart from each other, but parallel to each other.

The proposal provides a blocking state in which the blocking part 6 blocks a pivoting movement of the holding part 4 out of one of the two closing positions in the direction of the open position. For this purpose, the blocking part 6 is pivotable into a blocking position in which a blocking surface 7 of the blocking part 6 and a blocking surface 8, 9 of the holding part 4 are in blocking engagement with each other and block a pivoting movement of the holding part 4, as discussed above (FIG. 2). It can be gathered from FIGS. 2a and 2b that the holding part 4 has a first blocking surface 8 for realizing the pre-closing position and a second blocking surface 9 for realizing the main closing position. The blocking surface 7 of the blocking part 6 comes into engagement with the first blocking surface 8 or the second blocking surface 9 of the holding part 4, depending on the respective closing position of the holding part 4.

The arrangement is now configured in such a manner that, in the blocking state, the blocking part 6, with holding part 4 in the pre-closing position, has a closing tendency and, with the holding part 4 in the main closing position, has an opening tendency. The term “closing tendency” means here that, in the blocking state, the blocking part 6 is pushed by the holding force F, which is yet to be explained, further into engagement with the blocking surface 8 of the holding part 4. This corresponds to a loading of the blocking part 6 in the engagement direction, counterclockwise in FIG. 2. In the present case, the term “opening tendency” means that, in the blocking state, the holding force F pushes the blocking part 6 out of engagement with the holding part 4. This corresponds to a loading of the blocking part 6 in the lifting direction, clockwise in FIG. 2.

In order to open the motor vehicle lock 2, the blocking part 6 is lifted into a release position (FIG. 1) in which the blocking surfaces 7; 8, 9 are disengaged from each other and release the holding part 4. In order to release the holding part 4, which is in the pre-closing position, the blocking part 6 is pivoted clockwise via an opening mechanism 10, which is merely indicated schematically in FIG. 2a. In order to release the lock latch 3 from the main closing position, a second blocking part 11 is moved out of the movement range of the blocking part 6 via a further opening mechanism 12, which is likewise merely indicated in FIG. 2b. For the basic manner of operation of the detent mechanism illustrated in the drawing, reference should be made to German utility model DE 20 2013 004 589 U1 which originates from the applicant and the content of which is hereby made the subject matter of the present application.

It is now essential that, in the blocking state, in order to limit an axial offset, with respect to the holding part axis 4a, between the blocking surface 7 of the blocking part and the respective blocking surface 8, 9 of the holding part 4, a supporting surface 13 of the blocking part 6 and a supporting surface 14, 15 of the holding part 4 are in axially supporting engagement with each other or can be brought into axially supporting engagement with each other. Here a first supporting surface 14 is assigned to the holding part 4 for the pre-closing position and a second supporting surface 15 is assigned thereto for the main closing position.

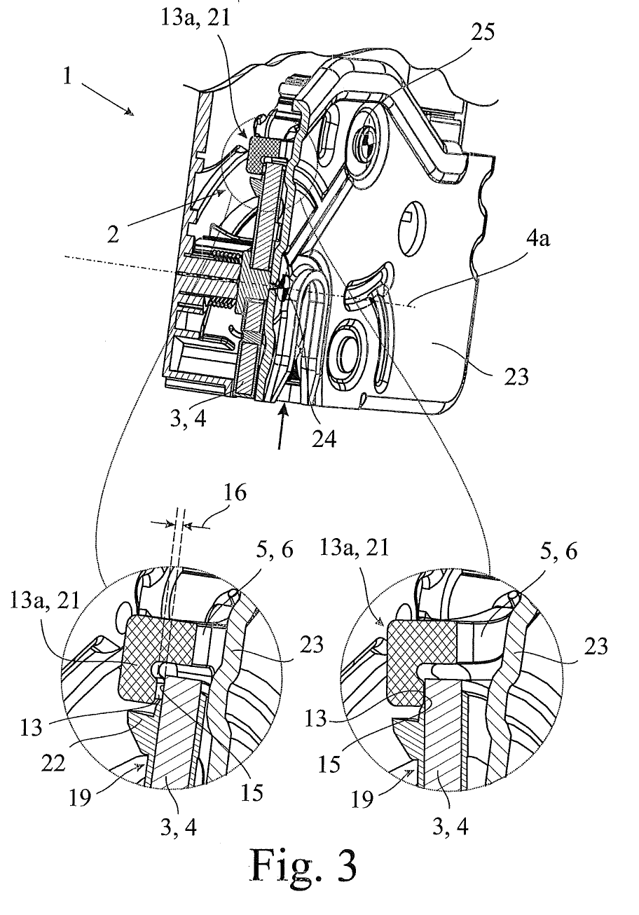

The detailed illustration on the left in FIG. 3 shows the proposed detent mechanism 1 during normal operation in the blocking state with holding part 4 located in the main closing position. A crash-induced axial displacement, with respect to the holding part axis 4a, of the blocking surface 9 of the holding part 4 to the left in FIG. 3 leads to the supporting surface 15 of the holding part 4 coming into engagement with the supporting surface 13 of the blocking part 6. Upon further deformation, the holding part 4 carries along the blocking part 6 via the supporting surfaces 13, 15 without adversely affecting the blocking engagement between holding part 4 and blocking part 6. This is shown in the detailed illustration on the right in FIG. 3.

It can be gathered from the detailed illustration on the left in FIG. 3 that, during normal operation, the supporting surface 15 of the holding part 4 and the supporting surface 13 of the blocking part 6 form a gap 16, i.e. are disengaged from each other. It is therefore ensured that the proposed solution does not adversely affect the functioning of the detent mechanism 1 due to additional friction or the like.

FIGS. 2 and 3 furthermore show that, in the blocking state, the supporting engagement always takes place in the vicinity of the blocking engagement. This means that support is provided precisely at the point at which the axial offset with respect to the holding part axis 4a is intended to be limited. As a result, lever actions and deformations between the supporting surfaces 13; 14, 15, on the one hand, and the blocking surfaces 7; 8, 9, on the other hand, do not have to be taken into consideration in the configuration.

In the exemplary embodiment which is illustrated, the supporting surface 13 of the blocking part 6 is an integral component of the blocking part 6. As an alternative thereto, provision may be made for the supporting surface 13 of the blocking part 6 to furthermore be fitted onto the blocking part 6 or to furthermore be injection molded onto the blocking part 6 in a plastics injection molding process. The same applies to the respective supporting surface 14, 15 of the holding part 4.

FIG. 3 shows that the supporting surface 13 of the blocking part 6 and the respective supporting surface 14, 15 of the holding part 4 each run substantially perpendicularly to the holding part axis 4a. As an alternative thereto, provision may also be made for only the supporting surface 13 of the blocking part 6 or only the respective supporting surface 14, 15 of the holding part 4 to run substantially perpendicularly to the holding part axis 4a.

The blocking surfaces 7; 8, 9 run essentially along the holding part axis 4a. Provision may be made in turn here for only one of the blocking surfaces 7; 8, 9 to run along the holding part axis 4a.

FIG. 3 shows that the supporting surface 13 of the blocking part 6 and the supporting surfaces 14, 15 of the holding part 4 are not only oriented differently, but are arranged with respect to the blocking surface 7 of the blocking part 6 and/or the respective blocking surface 8, 9 of the holding part 4 in a manner offset axially with respect to the holding part axis 4a.

As discussed above, the holding part 4 can have a lock latch 3 while the blocking part 6 can have a pawl 5. In the exemplary embodiment illustrated, the holding part 4 is even a lock latch 3 of a motor vehicle lock 2, which lock latch, when a fitted motor vehicle lock 2 is in the closing position, is in holding engagement with a striker 17 or the like, wherein the blocking part 6 is a pawl 5 of a motor vehicle lock 2.

In the blocking state with lock latch 3 located in the pre-closing position (FIG. 2a) and with lock latch 3 located in the main closing position (FIG. 2b), the lock latch 3 is in holding engagement with the striker 17. The striker 17 then exerts the holding force F, which has already been discussed above, on the lock latch 3. The pawl 5 acts counter to the holding force F via the above-discussed locking engagement in respect of a pivoting movement of the lock latch 3. While the motor vehicle lock 2 can be arranged on the associated closure element, the striker 17 or the like can be found on the body of the motor vehicle.

In the exemplary embodiment illustrated, the lock latch 3 is of substantially disk-shaped design, wherein the respective blocking surface 8, 9 of the lock latch 3 is arranged on the outer circumference 18 of the lock latch 3. By contrast, the respective supporting surface 14, 15 of the lock latch 3 is arranged on a flat side 19 of the lock latch 3. The supporting force between lock latch 3 and pawl 5 can be oriented substantially transversely with respect to the flat side 19 of the lock latch 3.

The lock latch 3 has an inlet mouth 20 into which the striker 17 or the like runs during the closing of the associated closure element. The lock latch 3, driven by the striker 17 or the like, pivots here into one of the closing positions thereof, anticlockwise in FIG. 1.

An overall view of FIGS. 2 and 3 shows that both the supporting engagement via the supporting surfaces 13; 14, 15 and the blocking engagement via the blocking surfaces 7; 8, 9 are provided in the region of the outer circumference 18 of the lock latch 3. This is substantially based on the consideration that the blocking of the lock latch 3 at the outer circumference 18 is possible with relatively little blocking force and that the proposed supporting, as discussed above, can be intended to take place in the vicinity of the blocking engagement.

Numerous structural variants are conceivable for the supporting engagement between lock latch 3 and pawl 5. Here, the supporting surface 13 of the pawl 5 is part of a supporting tab 21 which furthermore protrudes from the pawl 5. The pawl 5 here is designed as a punched and bent part, wherein the supporting tab 21 is furthermore bent away from the pawl 5. As an alternative thereto, provision may also be made for the supporting portion 13a providing the supporting surface 13 to furthermore be fastened to the pawl 5. Furthermore, it is conceivable for the supporting portion 13a to furthermore be injection molded onto the pawl 5 in a plastics injection molding process.

As discussed above, the supporting portion 13a advantageously not only has the proposed supporting function. Rather, the supporting portion 13a of the pawl 5, here the supporting tab 21, provides an engagement depth limit. This is based on the fact that the pawl 5 can enter into engagement with the pawl 5 in an engagement direction, counterclockwise in FIG. 2, and that the pawl 5 can be lifted counter to the engagement direction, clockwise in FIG. 2. Since the pawl 5 can be pretensioned by a spring in the engagement direction, an engagement depth limit has proven basically advantageous. In an embodiment, the lock latch 3 is provided with a limit contour 22 with which the supporting portion 13a comes into engagement in the event of a predetermined engagement depth of the pawl 5. Here, the limit contour 22 is arranged on the lock latch 3, such as on the above flat side 19 of the lock latch 3.

In the exemplary embodiment illustrated, an above engagement depth limit is provided only for the main closing position of the lock latch 3. By means of the ramp-shaped blocking surface 9 there, without an engagement depth limit the pawl 5 would slide down along the blocking surface 9 during the adjustment of the lock latch 3 from the main closing position into an overtravel position. The subsequent resetting, caused by high counter pressures of the door seal, of the lock latch 3 into the main closing position would lead via the ramp-shaped blocking surface 9 to an undesirable acceleration of the pawl 6 in the lifting direction. The above-discussed engagement depth limit prevents such a movement of the pawl 5 in overtravel.

According to a further teaching, a motor vehicle component is provided with a proposed detent mechanism. Reference should be made to all of the statements regarding the proposed detent mechanism.

In an embodiment, the motor vehicle component is a motor vehicle lock which, as explained above, has a lock latch 3 and a pawl 5. In an embodiment, the motor vehicle lock 2, as illustrated in FIG. 3, is provided with a striking plate 23 for receiving bearing pins 24, 25 for the lock latch 3 and the pawl 5, wherein, in the blocking state, the lock latch 3 is enclosed between the supporting surface 13 of the pawl 5 and the striking plate 23. This can best be gathered from the illustration according to FIG. 3. It is apparent from said illustration that the above enclosure of the lock latch 3 provides a high degree of robustness in the two possible axial displacement directions of the respective blocking surface 8, 9 of the lock latch 3.

The proposed solution very generally provides a high degree of crash safety for a motor vehicle lock 2 in which, in the fitted state, a high, in particular crash-induced holding force F acting on the striker 17 or the like leads to deformation of the motor vehicle lock 2, the deformation being essentially associated with an axial shifting of the respective blocking surface 8, 9 of the lock latch 3 with respect to the holding part axis 4a. It is essential here that the blocking surface 7 of the pawl 5 substantially follows said axial shifting of the respective blocking surface 8, 9 of the lock latch 3 by means of the supporting engagement between the supporting surfaces 13; 14, 15. This can be gathered in the right detailed illustration according to FIG. 3. That part of the lock latch 3 which has the blocking surface 9 is displaced there to the left, which leads by the proposed supporting engagement between lock latch 3 and pawl 5 to the pawl 5 likewise being displaced to the left. The overlap, which is necessary for the blocking engagement, between the blocking surfaces 7; 8, 9 is ensured despite structural deformation of the motor vehicle lock 2.

What is claimed is:

1. A detent mechanism for a motor vehicle component, the detent mechanism comprising:
a pivotable holding part; and
a pivotable blocking part;
wherein the holding part is pivotable into a closing position and into an open position about a holding part axis;
wherein a blocking state is produced by the blocking part being pivotable into a blocking position in which a blocking surface of the blocking part and a blocking surface of the holding part are in blocking engagement with each other and block a pivoting movement of the holding part out of the closing position in the direction of the open position;
wherein the blocking part is pivotable into a release position in which the blocking surfaces are disengaged from each other and release the holding part; and
wherein, in the blocking state, with respect to the holding part axis, between the blocking surfaces, a supporting surface of the blocking part and a supporting surface of the holding part are in axially supporting engagement with each other or can be brought into axially supporting engagement with each other.

2. The detent mechanism of claim 1, wherein, during normal operation, the supporting surface of the holding part and the supporting surface of the blocking part form a gap.

3. The detent mechanism of claim 1, wherein, in the blocking state, the supporting engagement is provided in the vicinity of the blocking engagement.

4. The detent mechanism of claim 1, wherein the supporting surface of the blocking part is an integral component of the blocking part, and/or wherein the supporting surface of the holding part is an integral component of the holding part.

5. The detent mechanism of claim 1, wherein at least one of the supporting surface of the blocking part and the supporting surface of the holding part runs substantially perpendicularly to the holding part axis.

6. The detent mechanism of claim 1, wherein at least one of the blocking surface of the blocking part and the blocking surface of the holding part runs substantially along the holding part axis.

7. The detent mechanism of claim 1, wherein the supporting surface of the blocking part and the supporting surface of the holding part are arranged with respect to the blocking surface of the blocking part and/or the blocking surface of the holding part in a manner offset axially with respect to the holding part axis.

8. The detent mechanism of claim 1, wherein the holding part is a lock latch of a motor vehicle lock, wherein the lock latch, in the closing position, is in holding engagement with a striker, and wherein the blocking part is a pawl of the motor vehicle lock.

9. The detent mechanism of claim 8, wherein the lock latch is of substantially disk-shaped design, wherein the blocking surface of the lock latch is arranged on an outer circumference of the lock latch, and wherein the supporting surface of the lock latch is arranged on a flat side of the lock latch.

10. The detent mechanism of claim 9, wherein both the supporting engagement and the blocking engagement are provided in the region of the outer circumference of the lock latch.

11. The detent mechanism of claim 8, wherein the supporting surface of the pawl is a component of a supporting tab that protrudes from the pawl, and wherein the supporting tab is bent away from the pawl.

12. The detent mechanism of claim 11, wherein the supporting tab provides an engagement depth limit.

13. The detent mechanism of claim 11, wherein the pawl is designed as a punched and bent part.

14. The detent mechanism of claim 11, wherein the supporting tab comes into engagement with a limit contour at a predetermined engagement depth of the pawl.

15. The detent mechanism of claim 14, wherein the limit contour is arranged on the lock latch.

16. A motor vehicle component, comprising the detent mechanism of claim 1.

17. The motor vehicle component of claim 16, wherein the motor vehicle component is a motor vehicle lock, wherein the holding part is a lock latch of the motor vehicle lock, wherein the lock latch, in the closing position, is in holding engagement with a striker, and the blocking part is a pawl of the motor vehicle lock, and wherein a striking plate is provided for receiving bearing pins for the lock latch and the pawl, and wherein, in the blocking state, the lock latch is enclosed between the supporting surface of the pawl and the striking plate.

18. The motor vehicle component of claim 17, wherein, in the fitted state, a holding force acting on the striker leads to deformation of the motor vehicle lock, the deformation being substantially associated with an axial shifting of the blocking surface of the lock latch, and wherein the blocking surface of the pawl substantially follows the axial shifting due to the supporting engagement between the supporting surfaces.

19. The motor vehicle component of claim 17, wherein, in the fitted state, a crash-induced holding force acting on the striker leads to deformation of the motor vehicle lock, the deformation being substantially associated with an axial shifting of the blocking surface of the lock latch, and wherein the blocking surface of the pawl substantially follows the axial shifting due to the supporting engagement between the supporting surfaces.
